(19) United States
(12) Patent Application Publication
(10) Pub. No.: US 2013/0268456 A1
(43) Pub. Date: Oct. 10, 2013

(54) FREIGHT MANAGEMENT APPLICATION FOR MOBILE PHONE

(71) Applicant: James D. Gumro, Bruce Township, MI (US)

(72) Inventor: James D. Gumro, Bruce Township, MI (US)

(21) Appl. No.: 13/854,408

(22) Filed: Apr. 1, 2013

Related U.S. Application Data
(60) Provisional application No. 61/621,677, filed on Apr. 9, 2012.

(51) Int. Cl. G06Q 10/08

(52) U.S. Cl. CPC G06Q 10/083
USPC 705/333; 235/375

(57) ABSTRACT

A mobile device for managing freight shipment is disclosed. The device has a data entry interface configured to receive bar code data for the logistic management specialist and store the bar code data in a logistic management specialist log residing on the device. The device has a selection module that operates to selectively analyze the packages measure in the logistic management specialist log and select a given structural collection procedure from a plurality of standardized collection procedures.

This application claims the benefit of U.S. Provisional Application No. 61/621,677, filed on Apr. 9, 2012. The entire disclosure of the above application is incorporated herein by reference.

### FIELD

The present disclosure relates to a mobile computing device for managing freight shipment of a logistic management specialist and, more particularly, to a mobile computing device which administers structured collection procedures for shipment related indicators and transmits them via a wireless network to a freight logistic manager.

### BACKGROUND

Freight and logistics organizations operate in an increasingly challenging environment. To survive, freight and logistics organizations must adapt to this environment and execute in a clear, consistent, and efficient manner. Furthermore, the competitive nature, low profit margins, and foreign competitive challenges of freight and logistics businesses greatly increase the complexity and difficulty of surviving on a day-to-day basis.

Therefore, a need exists for an efficient and effective system and method to assess the performance level of key assessment areas within the processes of a logistics organization. Management of freight is complex as the level of package location entering the commerce stream is dynamic. Variation of location in the commerce stream that controls the transport of packages out of the commerce stream also complicates freight management. Packages' locations are sensitive to plane, train and automobile traffic, but also can be affected by internal processes at manufacturers, consumers, point of sale, and unique to individual logistic management specialists. The dynamic nature of packages' locations and, all other factors affecting packages' locations, often require a person with freight to forecast packages' locations.

Management of freight is often difficult because of the need to reliably move transport information to a central database. Daily transportation information, such as timing and location, is typically obtained from hand held scanners which are physically positioned into a cradle at a central location. The cradle is typically coupled to a database which receives and stores the transportation information. Location and event information can be obtained by a shipper using a hand held scanner.

There is a need for a handheld device to aggregate, manipulate, manage, present, and communicate transportation data from scanning devices, logistic management specialist recorded information, in an efficient manner to improve the care and package's integrity of a person with freight, so the person with freight can lead a full life and reduce the risk of complications from freight. Additionally, there is a need to provide such a handheld device that can offer touch screen convenience. Furthermore, there is a need to provide an internal component configuration that can optimize the internal space of the handheld device.

Additionally, there is a need for a handheld freight management device that is able to provide an even more accurate tracking information to the user based on various user inputs that take into account current activities and a current package integrity of the user, and which is also highly customizable by the user to thus enhance the accuracy, convenience and efficiency.

There is a need for a logistic management specialist to be able to manage, manipulate and control the desired range of package locations over a period of time through a hand-held device in an efficient manner to improve the tracking and package integrity of a package with freight, so the transporter with freight can lead to an efficient transport and reduce the risk of damage to the freight.

Management of freight involves large amounts of transportation data and prescriptive data that are acquired from scanning devices, personal package integrity devices, logistic management specialist recorded information, package integrity professional data configurations results, prescribed transfer of responsibility and recorded information. Producers with freight and their package integrity professionals interact with a variety of scanning devices and systems to help manage package tracking, including performing structured collection procedures. For each of these differing types of scanning devices, there is a need to aggregate, manipulate, manage, present, and communicate transportation data and prescriptive data from data sources in an efficient manner to improve the package integrity of a person with freight, so the person with freight can lead a full life and reduce the risk of complications from freight.

When designing an overall system for freight management or an application residing on a given bar code reading device in the system, there is a further need to identify and implement extension points in the system to support future growth. This section provides background information related to the present disclosure which is not necessarily prior art.

### SUMMARY

This section provides a general summary of the disclosure, and is not a comprehensive disclosure of its full scope or all of its features. The device has a data entry interface configured to receive package integrity bar code measures for the logistic management specialist and store the bar code measures in a logistic management specialist log residing on the device. The device has a selection module that operates to selectively analyze the package's locations and information in the logistic management specialist log and select a given structural collection procedure from a plurality of standardized collection procedures.

According to an alternate teaching, the mobile device as disclosed above further has an administrative module in data communication with the data store. The administrative module prompts the logistic management specialist, via the display device, to input bar code measures into the data entry interface.

According to an alternate teaching, any of the above systems further has a wireless transceiver configured to transmit freight data through a telephone network to a freight transmission service provider. A data analysis module operates selectively to analyze the bar code measures in the logistic management specialist log and interfaces with the wireless transceiver to transmit the package locations to a package shipment service provider when one of a predetermined amount of time or a predetermined number of package location samples are taken.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a system for managing location levels according to the present teachings;

FIG. 2 represents a mobile computing device according to the present disclosure;

FIG. 3 represents a diagram of system modules defined within a cellphone according to the present teachings;

FIG. 4 represents a flowchart of structured data configuration protocols in predetermined routines according to the present teachings;

FIGS. 5a-5c represent screen data from the system of the present teachings;

FIG. 6 represents a flowchart describing an exemplar decision process regarding the application of structured data configuration protocols;

FIG. 7 is a diagram representing the flow of information within the system.

FIG. 8 represents a system diagram according to the present teachings; and

FIGS. 9-12 represents screens for the mobile device according to the present teachings.

Corresponding reference numerals indicate corresponding parts throughout the several views of the drawings.

### DETAILED DESCRIPTION

Example embodiments will now be described more fully with reference to the accompanying drawings.

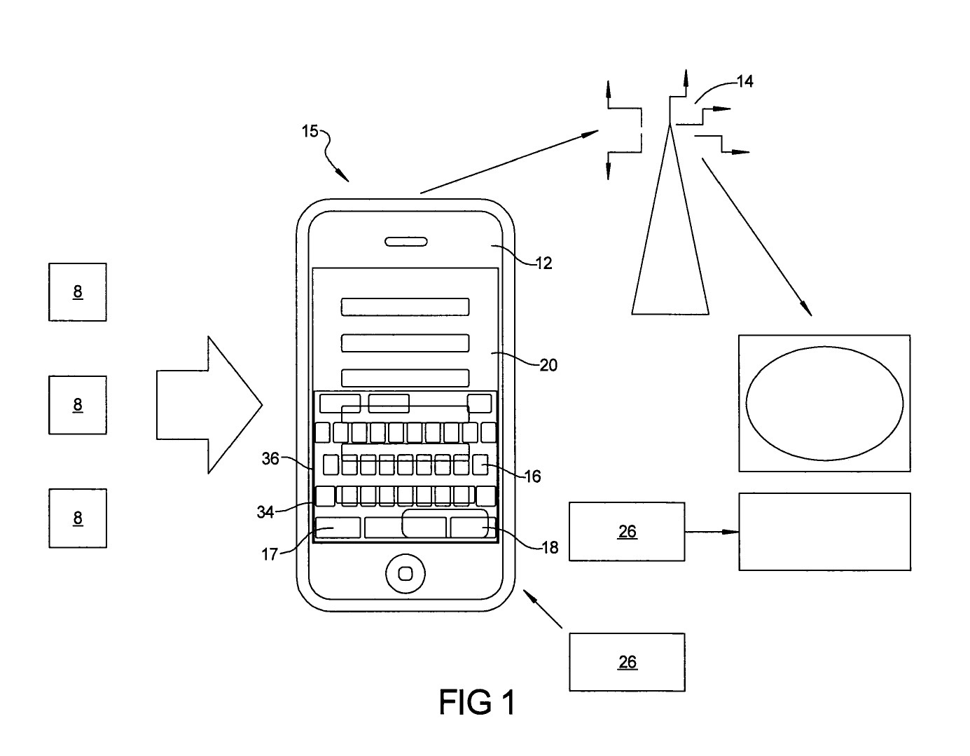

As shown generally in FIGS. 1-6, the system for managing freight shipment 10 of a logistic management specialist according to the present teachings provides a mobile phone or computing device 12 capable of allowing manual entry and storage of package shipping location information. The location information can be automatically inputted using applicable GPS location systems. The system for managing freight shipment 10 of a logistic management specialist also provides for a communications system 15 to allow the transfer of shipping data through a telephone network 14 to a shipping source provider via email or messaging protocol.

A first instruction set 16 within the mobile computing device 12 functions to support functionality not directly associated with the wireless communication of shipping data, while a second instruction set 17 within the mobile device functions to support the functionality related to communicating the shipping data through the communications system 15. The first instruction set 16 supports functionality which can be, for instance, data entry, reminders, the prompting of structured data configuration procedures, and simple reporting through a display screen 20. As described further below, when network access is available, shipping data can be uploaded to package 8 shipment service providers.

The mobile computing device 12 through the second instruction set 17 is configured to communicate shipping data through mobile environments such as a wireless telephone system or hybrid-web local application to transfer the shipping data. Optionally, the communications system 15 can transfer the data using protocols AC360 DMS web and blue tooth protocol. In addition to the manual entry of data, other devices 26 can automatically update shipping information into the mobile computing device 12. These devices 26, for example, include blue tooth enabled laser implemented bar code scanner meters, cameras, and weight scales. Optionally, additional non-logistic management specialist shipping information from cloud based databases can be uploaded to the mobile computing device 12. This information can be updated and incorporated through the wireless system into the mobile computing device 12 as a software update. These datasets can, for example, include location dosing advice, additional structured protocols, and food database information.

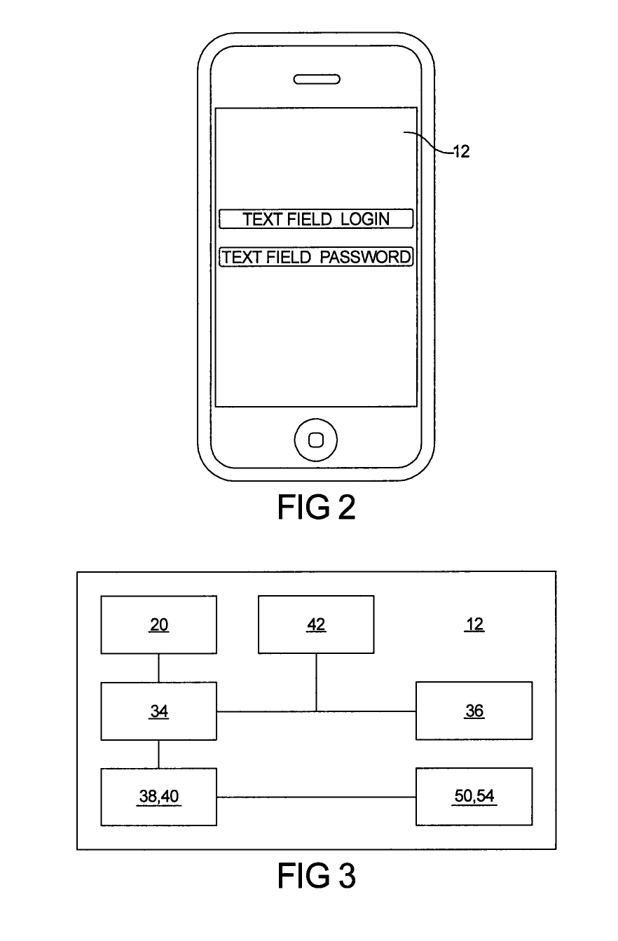

As shown in FIGS. 1 and 2, the mobile computing device 12 has a data input mechanism 18 such as a keyboard. As is known, the data input mechanism 18 can be integrated into the display screen 20. Optionally, the display screen 20 will prompt the user to input shipping factors 22 such as package 8 location, package integrity, and weight. The user has the ability to vary the value of the units for the packages being inputted such as time in a 24 hour or 12 hour configuration.

At various times, as described in detail below, the mobile computing device 12 can prompt the user to input laser or optically read or implemented bar code scanner readings. These can either be a single one dimensional laser implemented bar code scanner input, one dimensional laser implemented bar code scanner inputs or two dimensional inputs. The mobile computing device 12 can supply default laser implemented bar code scanner target codes which can vary based on a geographic region of the world or based on international standards. In addition to prompting a user for locational measurements, the mobile computing device 12 allows for the user to input other information which may be useful to a shipping professional. This information can, for example, include measures of shipping quality control, a vehicle movement schedule, and a physiological state of the packages. The mobile computing device 12, through the display, can additionally allow the user to configure the mechanism so that reminders can occur. For instance, audible or vibrating reminders can occur. Additionally, the user can update the desired laser implemented bar code scanner value. The inputted value should be checked to determine if it is within an acceptable level.

As best seen in FIG. 3, a representative mobile computing device 12 has a display screen 20, data entry interface 34 and log 36. The data entry interface 34 is configured to receive bar code measures for the logistic management specialist and store the bar code measures in the log 36. An associated data store 38 stores a plurality of structured collection procedures 40. As described below, each structured collection procedure 40 specifies one or more collection events for obtaining bar code measures from the logistic management specialist.

The mobile computing device 12 further has a selection module 42 that operates selectively to analyze the shipping data such as bar code measures in the log 36 and select and present to the user, through alarms and prompting, a given structured collection procedure 40. An administrative module 50 in data communication with the data store 38 prompts the logistic management specialist to input bar code measures into the data entry interface in accordance with the structured collection procedure 40. A wireless transceiver 54 is coupled to an administrative module 50 and is configured to transmit data from the log 36 to a shipping logistics professional through the wireless telephone network 14.

A data analysis module 52 associated with the administrative module 50 selectively operates to analyze the bar code measures in the log 36 and interface with the transceiver 54 to transmit the data from the log to a shipping logistics professional when the shipping data is outside of a predetermined window. Additionally, shipping data can be transmitted at predetermined time intervals, when a predetermined number of samples are collected or as requested by a shipping logistics professional. Upon detecting certain events, the administrative module 50 may prompt a logistic management specialist to engage in a more rigorous structured collection procedure 40 or may request further data related to shipping logistics events. This may occur if, for instance, the package 8 location or delivery time in the log 36 is trending in an undesirable direction.

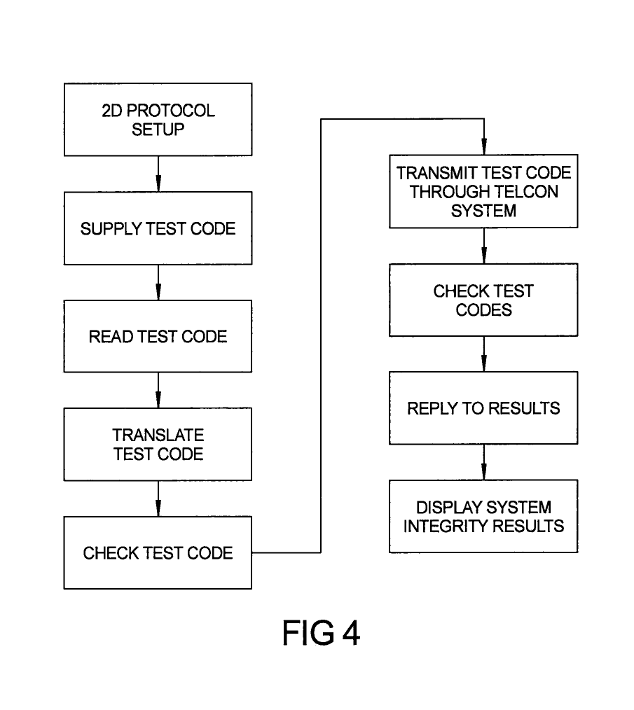

As is shown in FIG. 4, the mobile computing device 12 allows for the manual or automatic prompting of one of several structured data configuration regimes or procedures 40 as required by a shipping logistics professional. Additionally, an indication that a structured data configuration regime is running as well as its progress can be visible on the display screen 20. It is envisioned that at least two structured collection procedures 40 can be available. The first is a structured data configuration. The user can be prompted to set variables for the data configuration such as the start date and times in process block 58. During the structured data configuration, the mobile computing device 12 will prompt the user at each package 8 transfer to enter information related to the package 8 transfer as well as energy levels. The user will be notified through the display device when an extension of the data configuration regime is required due to incomplete laser implemented bar code scanner measurement data.

The results of each of the laser implemented bar code scanner data configurations may be recorded manually by the logistic management specialist. Optionally, a blue tooth-enabled devices 26 can transfer the data to the mobile computing device 12. The laser implemented bar code scanner data configurations need to be performed within the context for each of the above-described seven events (which may include a predetermined time window). As it is important that the logistic management specialist record all of the obtained laser implemented bar code scanner information correctly on the laser implemented bar code scanner data configuration chart, the mobile computing device 12 can prompt the logistic management specialist to take the appropriate data configuration with an alarm.

While configuring a profile data configuration, the user has the option to set a reminder 65 prior to the initiation of the data configurations. While running a profile, the system determines if the last entry is the last entry of the day, or of the data configuration regime. Should the entry be the last, the system stops the automatic alarm system. The system will confirm the data entries for the calendar are complete when five laser implemented bar code scanner entries have been stored within a twenty-four hour period. This is opposed to relying on calendar days for scheduling. At the end of one of the structured collection procedure 40, the system will allow the user to ask the shipping provider questions such as “What can I do next?” or “What questions do I have for my shipping logistics provider?”

Should the user or the system require a data configuration (see FIG. 4), the system will prompt the user to collect laser implemented bar code scanner data. This data configuration involves having an individual obtain pairs of laser implemented bar code scanner values before and after various events. For example, an individual can obtain a laser implemented bar code scanner value before a specific delivery, for example before a package 8 is moved into an intermediate building or vehicle, and another laser implemented bar code scanner value within a specified time after the leaving a vehicle or building. The “before” and “after” laser implemented bar code scanner values form a related “pair” of laser implemented bar code scanner values and can be used as data. Collecting and reviewing a plurality of related pairs of before/after laser implemented bar code scanner data configuration data for various events throughout the day, may allow a shipper to determine where inefficiencies occur in the shipping of freight.

In configuring a data configuration structured collection procedures 40, in the mobile computing device 12, the user is prompted to data configuration their laser implemented bar code scanner before and after a selected event for seven consecutive occurrences. The user can configure the data configuration by selecting from a list of data to be stored or transmitted. Optionally, this list can include the standard scan types of inputs as well as custom types of laser implemented bar code scanner value, laser implemented bar code scanner value, location list values, package integrity measures and time and dates information.

Data from either of the above described data configurations is stored within the log 36 either on the mobile computing device 12 or at a controlled location accessible through a wireless network. Additionally, examples of data which can be stored in the log 36 include package location, package integrity, package responsibility transfers, weight, and additional notes such as receiving customer satisfaction.

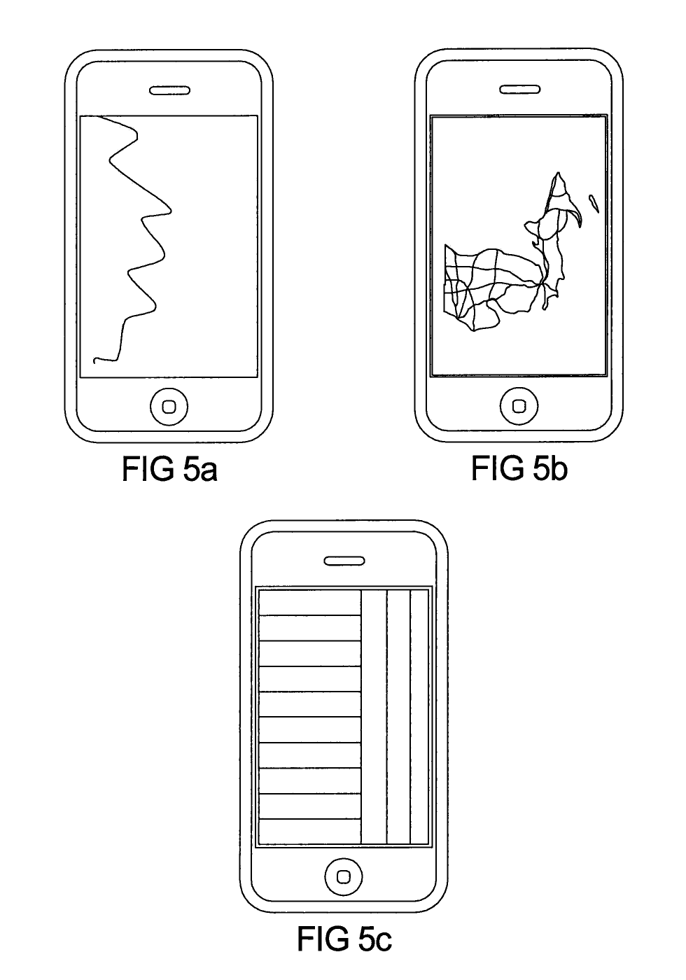

The mobile computing device 12 allows for a user to view the results in the form of graphs, reports, or maps. The mobile computing device 12 allows the user to view statistics such as a laser implemented bar code scanner trend report, data configuration report and data configuration report. An example of these reports is shown in FIGS. 5a-5c. The laser implemented bar code scanner trend graphs or statistics for one day, seven days, and thirty days are available. The system can limit the display to cover date ranges only, covering the entire amount of data stored. Optionally, only data related to a specific structured data configuration will be displayed or mapped.

FIG. 5b represents optional graphs of laser implemented bar code scanner from the report module used to inform the user of trends in their package 8 integrity data. The graphs can be viewed in portrait or landscape modes. The report module also can provide statistical information related to the package 8 integrity conditions. As detailed below, the wireless phone network can function to transmit the data from the logbook. Optionally, maps showing the timing of the location of deliveries and transfer of responsibility can be made.

FIG. 5c represents views of the logbook stored in the mobile device. Shown is package 8 integrity information along with date and time for the particular event. This data can be used by the analysis module to determine which data configuration protocol is best. The data depicted may be the data shown in the reports or data that is transferred to the freight management professional.

In the tabular view, the system will report information related to the number of data configurations; average number of data configurations per day; average laser implemented bar code scanner and standard deviation; average pre-package transfer and post-package transfer laser implemented bar code scanner values; total number and percentage of laser implemented bar code scanner values within the laser implemented bar code scanner target range; total number and percentage of laser implemented bar code scanner values above the laser implemented bar code scanner target range; total number and percentage of laser implemented bar code scanner values below the laser implemented bar code scanner target range but above the target value; and average daily total of deliveries per day. The output of the report can mirror the format of reports generated by known laser implemented bar code scanner meters. Graphs can be viewable in either portrait or in landscape, allowing panning and zooming of the view of the graph or mapped.

In configuring the mobile computing device 12, the user can set data units for the input of collected data. The system will have predefined units associated therewith. The user can optionally set target laser implemented bar code scanner levels with the advice of a shipping logistics professional. Additionally, the user can set a location list as well as a package 8 integrity list. The user also can optionally configure the second instruction set 17. In this regard, the user can configure automatic SMS messaging. This includes a selected list of recipients with corresponding telephone numbers. The user can be notified once an SMS, MMS or email message has been sent.

Additionally programmable is a log of reminders 65. In this regard, reminders 65 can include start date/time as well as recurrence of none, daily, weekly, monthly or selected days of the week. Optionally, the user can set the sound and volume of a reminder alert. The log of reminders 65 will be stored by name, allowing the user to retrieve them quickly. When a reminder occurs, the user can accept the reminder, snooze it, or dismiss (cancel) it. When the reminder is accepted, the user can be prompted to enter data. Optionally, when data has been entered with a predetermined time period of a scheduled time, the reminder will be cancelled.

As described above, the mobile computing device 12 contains a plurality of predefined structured collection procedures 40. The user can configure these structured data configurations. Optionally, the user can start and stop the structured collection procedure 40. The user should be able to identify by looking at the mobile device display that a structured data configuration is running, and its progress. The system can optionally allow only one structured data configuration to be running at a time.

While the structured data configuration is running, the system will prompt the user to perform laser implemented bar code scanner measurements for the structured data configuration at the configured times. The user can change the default settings to silence the reminders. When a user initiates a structured data configuration which has been previously run, the times set for the last data configuration will be revised. The mobile computing device 12 will indicate to the user when the structured data configuration is complete.

Users will be reminded to input package 8 transfer information, laser implemented bar code scanner and energy level. The user will be notified if an extension of the data configuration regime is required due to missing laser implemented bar code scanner data. In this regard, when data configuration data for a day is incomplete, the user will be able to discard the incomplete day and extend the data configuration.

The user can enter pre-event timing for each event. When the event is a package 8 transfer, the user can select from post event package 8 transfer options. Log data can be edited by a user as needed. The user will have the ability to create, edit or delete logbook entries. The user can optionally create a logbook entry consistent with a single laser implemented bar code scanner entry as well as date and time. Additionally, the user can log data as associated entries consisting of any combination of data values along with date and time. To increase the ease of entry, the user can alter the order of data entry.

Optionally, the first instruction set 16 will allow for separate or associated logs for package 8 location, package 8 integrity, package 8 transfer, transfer of responsibility and notes. Associated with each can be prescribed entry information such as location or transfer of responsibility name. With respect to package 8 location, should a structured collection procedure 40 be running, the user can indicate that they do not have laser implemented bar code scanner data to input. With respect to package 8 integrity, the mobile computing device 12 will accept text and picture values as well as date and time. With respect to package 8 transfers, the system can accept the name of the shipper and any associated representative value, such as a copy of a signature, package 8 identifier or package 8 transfer size indicators of SML along with date and time. Package 8 integrity can be recorded as high, medium or low value along with date and time.

The user can view the log entries prior to forwarding them to the freight logistic manager. The log data can be by date and time ranges. As described below, statistical reports are viewable on a graphical user interface on the mobile computing device 12. For example, laser implemented bar code scanner trend graphs can be viewed. A calculate trend line associated with recorded information can be displayed.

The logbook entry can consist of user editable date and time plus one other data value. Optionally, the acceptable date ranges, which can be edited, can be limited. For example, when a record is associated with a structured data configuration, the ability to edit the data field can be subdued. Data entered into the log can be converted into a standardized measure prior to storage in the log. In some circumstances, the user can have the option to take additional data configurations outside of a structured data configuration regime. As such, a user can be prompted to determine whether the data should be associated with the structured data configuration or just stored within the log. If the data is being entered when a structured is being conducted, the system will determine if the data is entered within an acceptance window for the structured data configuration. If the data is being entered within the structured data configuration acceptance window, the mobile computing device 12 will automatically associate the entered data with the data configuration.

The mobile computing device 12 can facilitate the backup of data log and user preference information. This backup can be either through the wireless system or through a wire coupled to the mobile computing device 12. It is envisioned the user can adjust factors such as the name and storage location for a backed up data log. Optionally, the user can back up the data file through the email system. The system provides a methodology to automate software updates. Within this functionality is ability for the user to delete the software, and optionally, all of its stored data and preface settings. Functionally, the user is allowed to update the software while maintaining their preferences and data logs.

To view the results of structured protocols such as the data configuration protocol, the user is prompted to determine if the results should be presented in tabular or chart format. In addition to the present report data, the result of former data configurations is also available.

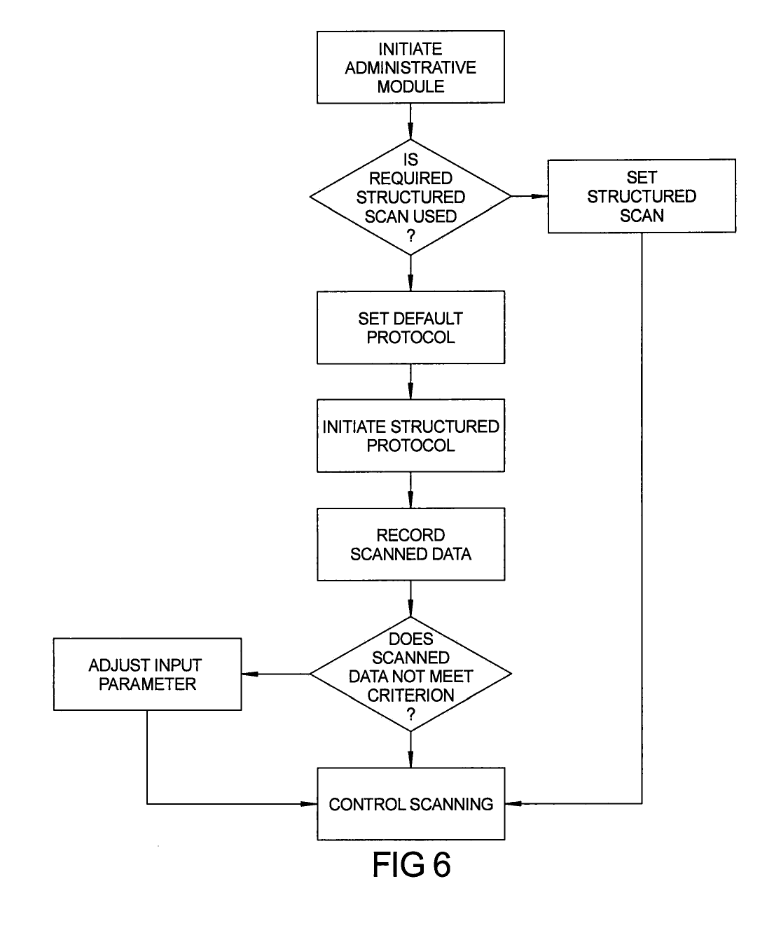

FIG. 6 represents a flowchart showing an optional control logic for the administrative module 50. This administrative module 50 functions to designate which of the several structured collection procedures 40 will be presented to the user. Optionally, the mobile computing device 12 will query the user to determine if a package 8 shipment service provider has required a specific structured data configuration be used 96. If a specific structured collection procedure 40 has been assigned, the system 10 will use the specified data configuration 98. The user will then be presented with an option to specify which structured data configuration they would like to use.

The administrative module 50 can optionally monitor the shipping information inputted by the user 100. Should the value of the data fall outside of a set of predetermined values, the administrative module 50 can take several intermittent but escalating steps to gather more information 102. These steps may be initiated if, for example, laser implemented bar code scanner level is trending toward an unacceptable level or if, for instance, shipment timing is trending into an unacceptable level without a corresponding change in package 8 integrity. In these scenarios, the administrative module 50 can prompt a user to input more information related to location. Additionally, the administration module 50 can request the user initiate one of the structures data configuration scenarios. Shipping information can further be forwarded via the communications system 15 to the shipping professional.

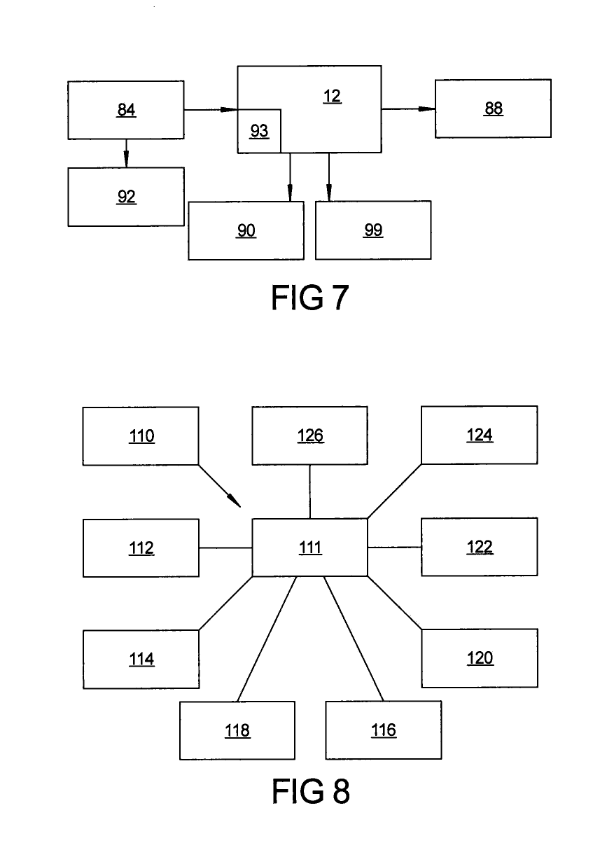

FIG. 7 represents a flow of information throughout the system 10. As shown, software 84 as shown above is downloaded into a mobile computing device 12. Registration information from the software 84 is forwarded to a shipping software provider 92. As described above, shipping data can be forwarded via email, MMS, SMS, HTTP or email to an analyst, a system administrator's computer 88, or a mobile device 90. This includes a mechanism for registering a user's name and information related to mobile computing device 12. This can, for example, include a phone number associated with the mobile device, and should the mobile computing device be a laser implemented bar code scanner meter, serial number information can be registered. In registering the user, the system will collect information related to the freight type as well as therapy type. When complete, the registration information will be emailed or transmitted via MMS or SMS to a specified location.

The mobile computing device 12 has a module 93 which allows for the configuration of SMS, MMS, HTTP or email transmission of information stored within the log. The module 93 is configured to allow the user to augment a list of recipients of the log information. Optionally, a code which functions as a pointer can be provided to the user. This code facilitates the automatic updating of several recipient numbers. The module 93 can support the removal or editing of a recipient's information. Optionally, the module can notify the user when data is transmitted.

As seen, the reports 99 can be sent to the freight management professional's computing device. In this regard, the report can be sent to the freight management professional's phone or computer 88. Additionally, the report can be sent to a data analysis system 86 to track shipping information related thereto.

As shown in FIG. 8, the system for managing location levels in a logistic management specialist can have an install module 110, a setting module 112, a logbook 114, a data export module 116, a reminder module 118, a structured data configuration module 120, a reporting module 122, a communications module 124, and an analytics module 126. The system functions to shepherd the installation of the software on to the mobile device using the install module 110. Optionally, the install module will interface with a home computer to automatically install updates to the software or pre-set variables or setting. From the install module 110, the system allows the home screen 111 to function as a central point within the software.

From the home screen 111, the user is prompted to go to the setting module 112. When started, the setting module 112 prompts or allows the user to set parameters such as laser implemented bar code scanner levels, units, location levels and package 8 transfer times. The setting module 112 also allows the user to set data sharing parameters in the data export module 116. These parameters can include which people or systems package 8 integrity information should be shared.

The setting module 112 also allows the user to set a reminders list in the reminder module 118. As described above, the reminders can include timing for location shots, laser implemented bar code scanner measurements or package 8 integrity. The home screen 111 allows the user to initiate the report module 122. The report module 122 allows the user to view trend reports for the various data configuration procedures and package 8 integrity parameters. From the reports module 122, the user can initiate the logbook 114. Optionally, the logbook 114 can be directionally initiated from the home screen 111.

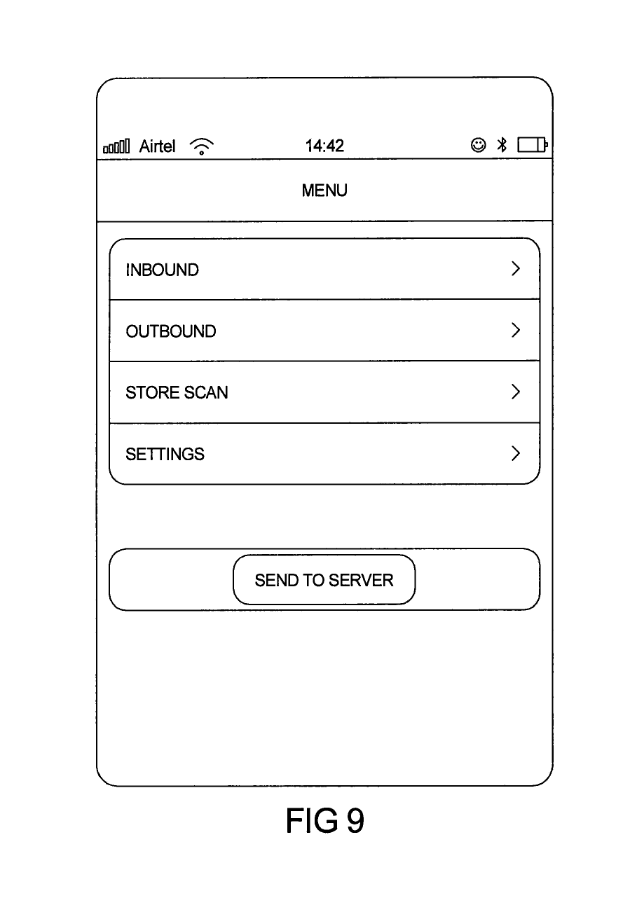

FIG. 9 represents a screen shot of data entry modules according to the present teachings. As can be seen, the system uses pop-up windows to allow the user to input data. The pop-ups can either display specific information, or can act as a location to enter information. This data can include data ranges, package 8 integrity, transfer of responsibility, date or time. The system can also use pop-ups to communicate an error condition for data entered or to confirm changes in the data.

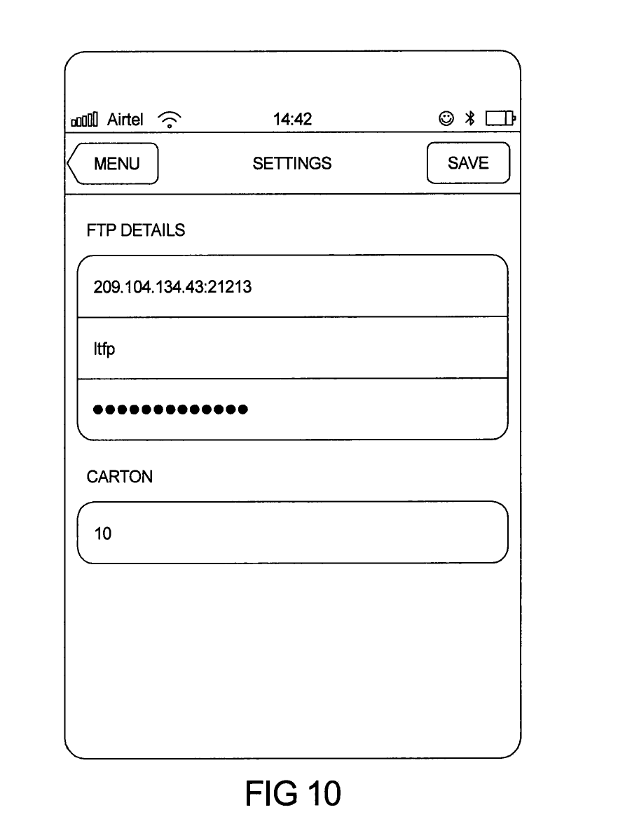

FIG. 10 shows examples of the setting module 112 which allows a user to input various types of data such as package 8 transfer time and type information, package 8 integrity, location, location type (by manufacturer or mix), the amount of package 8 integrity, and transfer of responsibility. Additional information can be directed to specific data configuration protocols. For instance, for a data configuration protocol, the system can record high laser implemented bar code scanner, low laser implemented bar code scanner, package 8 integrity list and location list. Package 8 transfer information can be entered as weight or package 8 transfer size. Information related to trends can relate to time such as 3, 7 or 30 days.

Shown are screens which allow the user to input information related to laser implemented bar code scanner and travel distance or number of deliveries for a data configuration protocol. Also shown is a screen which will allow the user to input package 8 integrity and location information. Additional information can be input. This includes energy level, amount and type of package 8 integrity, the intensity of package 8 integrity, transfer of responsibility taken, package 8 integrity or package 8 integrity parameters, as well as notes.

Optionally, a data sharing screen allows the user to configure where the data from the system should be transported. This transfer, which occurs over a wireless telecom system, can be via email or the transmission to a specific IP address. Upon initiation by the user, data from the logbook is transmitted by the cellphone network to the freight management professional or central computer. The user can configure portions of the communications module for a protocol. In this regard, a user is prompted to input an email address of a shipping logistics professional that is to receive shipping information. This information can, for instance, include some or all of the information stored in the logbook. A touch screen button allows for sending the information.

Optionally, an additional screen related to the reminder module. This screen attempts to gain the attention of the user to inform the user that information is needed by the system. Upon acknowledgment by the user, the reminder module will prompt the user to ask if the user would like to transfer to the data entry module. In the data entry module, specific data will be collected. Reminders can be set by day or hour times. Alarms can be set in the form of an audible or inaudible format. Additionally, snooze functions can be built in.

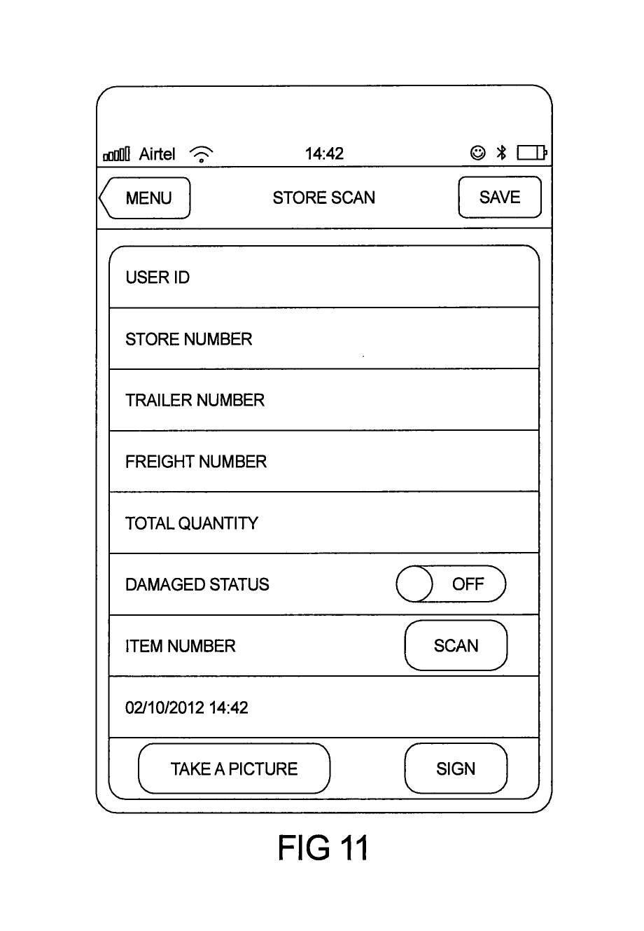

FIG. 11 represents a screen shot of inbound page from a mobile device according to the present teachings. As shown, the home page can be configured to contain useful information for the user. The user can view trend graphs of, for instance, a laser implemented bar code scanner, or the amount of required data configuration. Images of damage to the package can be made. This information can be stored in the logbook 114, data export module 116, reminder module 118, structured data configuration module 120, reporting module 122, communications module 124 or analytics module 126, and transmitted through the telecommunication module to the central shipping location. Images of the signature of a receiving or responsible party can be taken at any time during the movement of the package. This image as well as the image of a damage status of a package can be assigned time and location stamps.

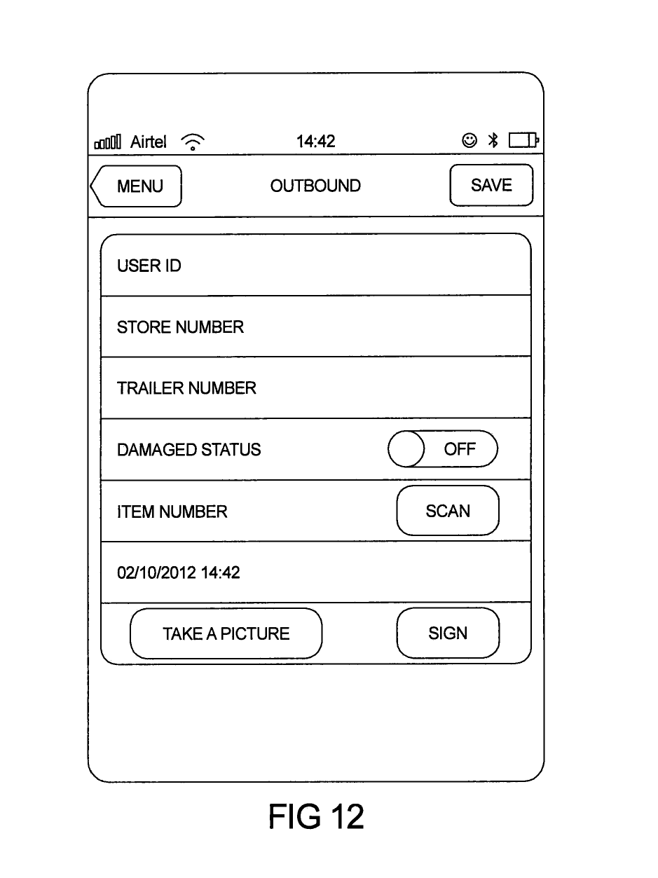

FIG. 12 represents a screen shot of an outbound page from a mobile device according to the present teachings. As shown, the home page can be configured to contain useful information for the user. The user can view trend graphs of, for instance, a laser implemented bar code scanner, or the amount of required data configuration. Trend graphs can be directed to a package 8 integrity parameter such as package 8 integrity or can be directed to information for a specific data configuration protocol. Also, the home page shows links to allow the user to get to the setting module 112, logbook 114, data export module 116, reminder module 118, structured data configuration module 120, reporting module 122, communications module 124 or analytics module 126.

Additional screen views for setting various parameters in the system can be used. Shown are screens which allow the setting of parameters such as location levels, package 8 transfer time settings, data sharing settings, laser implemented bar code scanner data sharing settings, backup and restore settings, and scanner settings. Optionally, the system can be responsive to touches on the screen. Additionally, the system can have pull down menus which will increase speed and decrease complexity of data input.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

Optionally, a validation on all scans can be conducted. Text files can be uploaded to the iPhone app containing the barcode numbers of each carton to ensure the correct cartons are being scanned. This functionality can be applied to the Inbound, Pallet, Outbound, and Store Scan functions of the application. Optionally, email notifications direct from iPhone. When the user is done scanning on any of the Inbound, Pallet, Outbound, or Store Scans, the system can email the scan file, signature files, and any pictures pertaining to the delivery to any email address they enter in the settings module of the application. Optionally, any of the screens can include a screen lock button now to lock out all fields of the application to ensure the user does not accidentally navigate away from the scan scree interrupting his scanning.

The term code, as used above, may include software, firmware, and/or microcode, and may refer to programs, routines, functions, classes, and/or objects. The term shared, as used above, means that some or all code from modules may be executed using a single (shared) processor. In addition, some or all code from modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mobile computing device for managing freight shipment used by a logistic management specialist, comprising:
a display device;
a data entry interface configured to receive bar code data and store the bar code data in a log residing on the device;
a data store that stores a plurality of structured collection procedures, where each of the structured collection procedures specifies one or more collection events for obtaining bar code data;
a selection module that operates selectively to analyze the bar code data in the log and select a given structured collection procedure from the plurality of structured collection procedures;
an administrative module in data communication with the data store and operable to prompt the logistic management specialist, via the display device, to input bar code data into the data entry interface, where the prompting of the logistic management specialist is in accordance with the given structured collection procedure;
a wireless transceiver configured to transmit data through a telephone network to a shipping logistics professional associated with the logistic management specialist; and
a data analysis module that operates selectively to analyze the bar code data in the logistic management specialist log and interfaces with the wireless transceiver to transmit data indicative of one of a package structural or temporal condition when a level of shipping data is outside of a predetermined window.

2. A system for managing the location of a package in a logistic management system, the system comprising:
a data entry module configured to record a package location and at least one package integrity parameter;
a display module;
a communications module having a cellphone transceiver;
a structured data retrieval module configured to run one of a data retrieving protocol, which is stored in a memory location; and
an analysis module configured to transfer data from the data entry module to a date log module, said analysis module having a logic module configured to selectively initiate an alarm module to run one of the data retrieving protocols and recursively prompt a logistic management specialist through the display module to input data, and in response to the input data selectively forwarding data to the communications module.

3. The system according to claim 2, wherein the display module presents a map of data indicative of package location.

4. The system according to claim 2, wherein the communications module is configured to transfer data via email, MMS, SMS, to a shipping logistics professional.

5. The system according to claim 2, wherein the logic module prompts the user for additional data based on changes in the levels of a package integrity parameter in the data log module.

6. The system according to claim 2, wherein the at least one package integrity parameter is selected from the group consisting of weight, physiological package state, package integrity, and location of evaluation.

7. A system for managing location levels in a logistic management specialist, the system comprising:
a data entry module configured to record package location and at least one package integrity parameter;
a setting module configured to accept user defined parameters;
a logbook module having a memory to track and memorialize changes in the package location and at the at least one package integrity parameter; and
an analytics module configured to transfer data from the data entry module, the settings module, and the logbook to selectively initiate a data retrieval protocol in response to the data.

8. The system according to claim 7, further comprising a structured data configuration module configured to manage a structured data configuration protocol.

9. The system according to claim 8, further comprising a communications module configured to transfer data from the logbook to a computer through a telecommunications network.

10. The system according to claim 7, further comprising a reminder module configured to provide reminders through a display device, the reminders requesting the user to record package location and at least one package integrity parameter through the data entry module.

11. The system according to claim 7, further comprising a display module coupled to the data entry module.

12. The system according to claim 7, wherein the data configuration protocol comprises a data configuration protocol and a data configuration protocol.

13. The system according to claim 7, further comprising a data export module coupled to the analytics module where a user can set data sharing parameters.

14. A system for managing location data in a logistic management system, the system comprising:
an install module configured to install software onto a mobile device;
a setting module configured to allow a user to set a plurality of user definable parameters on the mobile device and store them in a first memory location;
a logbook configured to store shipping information on the shipping device in a second memory location;
a data export module configured to export package integrity data from the second memory locations via a telecommunications system to a central computer;
a reminder module configured to prompt a logistics management specialist to enter package integrity data into the mobile device;
a structured data configuration module configured to prompt the user to enter data into the mobile device based on a structured laser implemented bar code scanner data configuration protocol;
a reporting module configured to report data within the logbook; and
a communications module configured to transmit data from the second memory location in the logbook to a central computer.

15. The system according to claim 14, wherein the setting module is configured to accept inputs via the mobile device to set parameters for the structured data configurations.

16. The system according to claim 14, wherein the mobile device comprises a wireless telephone and the communications module is configured to communicate data through a wireless telephone network.

17. The system according to claim 14, wherein the reporting module produces a map of laser implemented bar code scans over time.

18. The system according to claim 14, wherein the data log stores data from laser implemented bar code scanner, a timing indicator, and at least one package integrity parameter.

19. The system according to claim 14, further comprising an analysis module configured to initiate a structured data configuration based upon a calculation which uses data stored in the second memory location in the logbook.

20. The system according to claim 14, wherein the package integrity data comprises weight, package integrity, and product integrity.
